(19) United States
(12) Patent Application Publication
(10) Pub. No.: US 2011/0126861 A1
(43) Pub. Date: Jun. 2, 2011

(54) DESCALING ARRANGEMENT FOR A DISHWASHER, AND ASSOCIATED APPARATUS AND METHOD

(75) Inventors: Roberto Dorigo, Pordenone (IT); Fabio Colonnello, Pordenone (IT); Fabrizio Salton, Pordenone (IT); Alessandro Molinaro, Pordenone (IT); Daniele Armellin, Pordenone (IT); Gianmarco Vortali, Pordenone (IT); Giuliano Frascati, Pordenone (IT); Bryan John Henneman, Woodbury, MN (US); Andrew Michael Jensen, Saint Paul, MN (US); Jason Andrew Kahlhamer, Inver Grove Heights, MN (US); Christopher Daniel Morgan, Inver Grove Heights, MN (US); Ben Jeremiah Wiltsie, Cottage Grove, MN (US)

(73) Assignee: Electrolux Professional Spa AND Ecolab, Inc.

(21) Appl. No.: 12/861,337

(22) Filed: Aug. 23, 2010

Related U.S. Application Data
(60) Provisional application No. 61/236,188, filed on Aug. 24, 2009.

(51) Int. Cl. B08B 9/00

(52) U.S. Cl. 134/22.1; 134/104.1

(57) ABSTRACT

A descaling arrangement for a dishwasher and an associated apparatus are provided. The dishwasher has a tub portion adapted to receive dishware therein, and a fluid circulation system configured to circulate dishwashing fluid about the dishware within the tub portion. A descale system is in fluid communication with the fluid circulation system. The descale system is configured to selectively introduce a descaling substance into dishwashing fluid circulated within the fluid circulation system such that the descaling substance is distributed to at least one of the tub portion and the fluid circulation system for descaling thereof. An associated method is also provided.

### CROSS-REFERENCE TO RELATED APPLICATIONS

This application claims priority to U.S. Provisional Application No. 61/236,188, filed Aug. 24, 2009, which is incorporated by reference herein in its entirety.

### BACKGROUND OF THE INVENTION

1. Field of the Invention

Embodiments of the present invention relate to dishwashing appliances and, more particularly, to a descaling arrangement for a dishwashing appliance, and an apparatus and method associated therewith.

2. Description of Related Art

Generally, a dishwasher implements a hydraulic system including pumps, water lines, etc. for circulating water/fluid through spray arms or other water-distribution provisions of the dishwasher for washing the dishware therein in a continuous or intermittent manner. A typical dishwasher procedure may include a wash program for circulating detergent laden wash water about the dishware via the spray arms or other water-distribution provisions of the dishwasher. Thereafter, a rinse program may be provided for circulating clean rinse water about the dishware via the same or different spray arms. At least a portion of the wash water and the rinse water are heated to various predetermined levels (e.g., the wash water being heated to a temperature generally higher than 55° C. and the rinse water to a temperature generally equal to or higher than 82° C.) so as to improve the effectiveness and efficiency of the dishwasher, while also ensuring, in the case of the rinse water, proper sanitization of the dishware. A rinse aid may be usually added to the rinse water for facilitating removal of the detergent from the dishware.

However, during use of the dishwasher, insoluble solid limestone (calcium carbonate: CaCO₃) typically forms within the hydraulic system and/or the interior of the dishwasher exposed to the wash/rinse water. Limestone deposition is exacerbated by the increased temperatures of the wash/rinse water. In this regard, raising the temperature of the wash/rinse water reduces the level of carbon dioxide dissolved therein. As such, the reduction in dissolved carbon dioxide causes increased limestone deposition, which may lead to limestone deposits on the dishware, within the water lines, and the inner walls of the dishwasher. Furthermore, limestone precipitation on the heating elements of a boiler used to heat the rinse water has detrimental effects on the lifetime thereof and on the overall power consumption of the dishwasher, wherein the limestone deposition causes an increase of the power consumption for heating the rinse water and an increased rate of deterioration of the heating elements due to surface temperature increases thereof.

Moreover, due to the thermal shocks withstood in the various dishwasher programs, the limestone tends to detach as scales. Such limestone scales may enter into circulation throughout the hydraulic system and obstruct the spray nozzles of the spray arms. In addition, the limestone encrustations may form a strong insulator that slows down heat exchange between the boiler heating elements and the rinse water. Further, the forming of encrustations may reduce the cross sections of the water lines, causing a lower water flow rate with respect to the dishwasher request. Finally, the pumps (e.g., circulation/drain pumps) having encrustations on components thereof may require a power increase for overcoming the higher weight and friction, and thus risking breakdown.

Previously, the use of systems such as, water softeners, reverse osmosis, and chemical treatments that make a preliminary treatment of the water by lowering its hardness (i.e., extracting the calcium ions responsible for the limestone formation) have been used to combat limestone deposition. However, such systems attempt to prevent or reduce formation of the limestone, rather than cleaning or otherwise removing the limestone deposited within the hydraulic system and/or the inner walls of the dishwasher. In this regard, previous attempts to clean or remove limestone deposits have included periodically executing a general maintenance of the machine by manually cleaning the individual portions of the hydraulic system (water lines, spray arms, boiler, etc.) with acid solutions. However, such maintenance is labor-intensive and requires deconstruction of individual components of the dishwasher.

Accordingly, there exists a need for an apparatus and method for automatically descaling or otherwise removing limestone deposits, scales, and formations from the hydraulic system and other components of the dishwasher exposed to dishwashing fluid used during operation thereof, so as to reduce maintenance time and power consumption, while improving dishwasher reliability and performance.

### BRIEF SUMMARY OF THE INVENTION

The above and other needs are met by the present invention which, according to one aspect, provides a descaling arrangement for a dishwasher having a tub portion adapted to receive dishware therein and a fluid circulation system adapted to circulate dishwashing fluid about the dishware within the tub portion. The descaling arrangement includes a descale system adapted to be in fluid communication with the fluid circulation system. The descale system is configured to selectively introduce a descaling substance into dishwashing fluid circulated within the fluid circulation system such that the descaling substance is distributed to at least one of the tub portion and the fluid circulation system for descaling thereof.

Another aspect of the present invention provides a dishwasher, comprising a tub portion adapted to receive dishware therein, and a fluid circulation system configured to circulate dishwashing fluid about the dishware within the tub portion. A descale system is in fluid communication with the fluid circulation system. The descale system is configured to selectively introduce a descaling substance into dishwashing fluid circulated within the fluid circulation system such that the descaling substance is distributed to at least one of the tub portion and the fluid circulation system for descaling thereof.

Another aspect of the present invention comprises a method of descaling at least one of a tub portion and a fluid circulation system of a dishwasher, wherein the fluid circulation system is configured to circulate dishwashing fluid about dishware received within the tub portion. Such a method comprises selectively introducing a descaling substance via a descale system into dishwashing fluid circulating within the fluid circulation system such that the descaling substance is carried by the dishwashing fluid throughout the fluid circulation system. The descale system is in fluid communication with the fluid circulation system. The method further comprises circulating the dishwashing fluid and the descaling substance carried thereby within at least one of the tub portion and the fluid circulation system for descaling thereof.

Embodiments of the present invention thus provide advantages as otherwise detailed herein.

### BRIEF DESCRIPTION OF THE SEVERAL VIEWS OF THE DRAWINGS

Having thus described various embodiments of the invention in general terms, reference will now be made to accompanying drawings, which are not necessarily drawn to scale, and wherein:

FIGS. 1A and 1B are schematic side views of a dishwasher capable of implementing various embodiments of the present disclosure;

FIG. 2 is a schematic of a dishwasher having a descale system configured to introduce a descaling substance into a fluid circulation system of the dishwasher via a mixing chamber, according to one embodiment of the present disclosure, wherein the dishwasher includes a rack member movable in and out of a tub portion of the dishwasher;

FIG. 3 is a schematic of a dishwasher having a descale system configured to introduce a descaling substance into a fluid circulation system of the dishwasher via a mixing chamber, according to one embodiment of the present disclosure, wherein the dishwasher includes a rack conveyor system configured to automatically transport dishware in and out of a tub portion of the dishwasher;

FIG. 4 is a schematic of a dishwasher having a descale system configured to introduce a descaling substance into a pressurized water line of a fluid circulation system of the dishwasher, according to one embodiment of the present disclosure, wherein the dishwasher includes a rack member movable in and out of a tub portion of the dishwasher; and

FIG. 5 is a schematic of a dishwasher having a descale system configured to introduce a descaling substance into a pressurized water line of a fluid circulation system of the dishwasher, according to one embodiment of the present disclosure, wherein the dishwasher includes a rack conveyor system configured to automatically transport dishware in and out of a tub portion of the dishwasher.

### DETAILED DESCRIPTION OF THE EMBODIMENTS OF THE INVENTION

The present disclosure now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

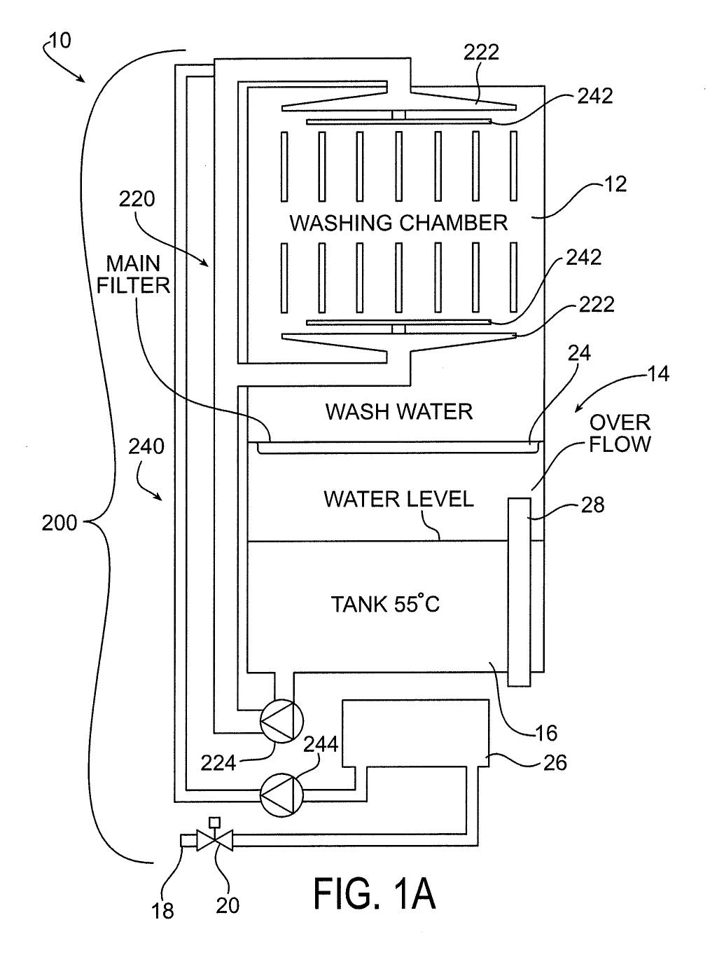

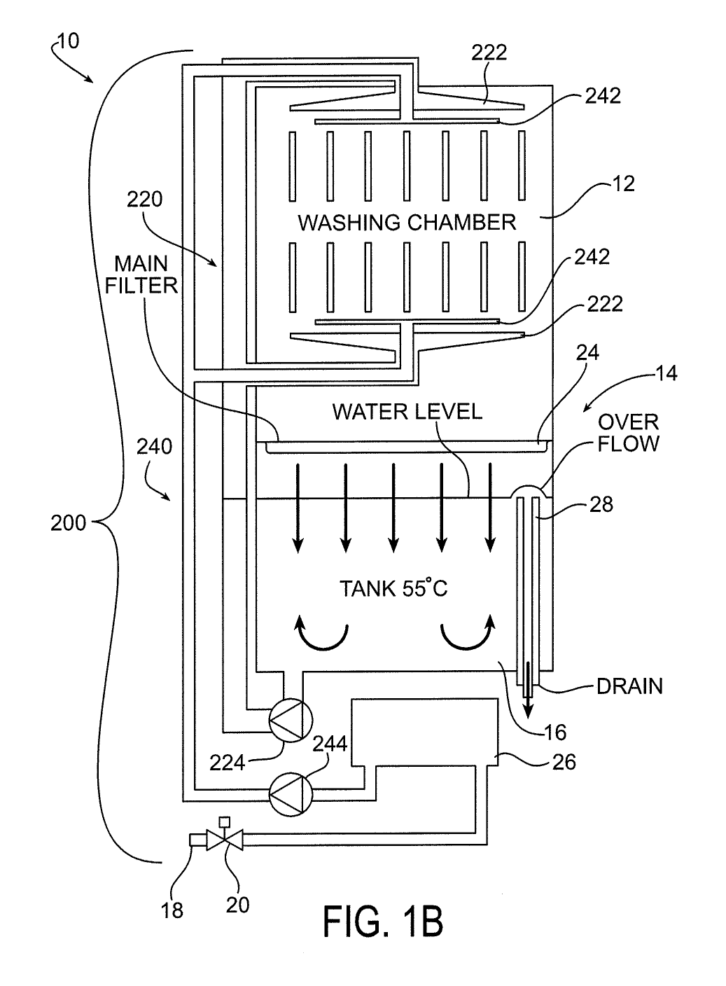

FIGS. 1A and 1B schematically illustrate one example of a dishwashing appliance, such as a dishwasher 10, capable of implementing various embodiments of the present invention. Such a dishwasher 10 includes a tub portion 12 having one or more walls for forming at least part of an enclosure in which dishes, utensils, and other dishware may be placed for washing. In some instances, the tub portion 12 may also define a forward access opening to facilitate movement of slidable lower and upper racks (not shown) in and out of the tub portion 12, wherein the lower and upper racks are configured to hold the dishes, utensils, and dishware to be washed. A door assembly (not shown) may be pivotably engaged with the tub portion 12 about the lower end 14 thereof so as to selectively permit access to the interior of the tub portion 12. The tub portion 12 may further define or have engaged therewith a wash tank 16 (or sump assembly), in which wash water or rinse water is collected, typically under the influence of gravity. In other embodiments, such as dishwashers 10 having a rack conveyor system as described below, the tub portion 12 can comprise any type of catchment for the wash, rinse or pre-wash waters, such as one having a sloped lower wall or floor leading to a drain without any vertical walls defining a periphery thereabout.

The dishwasher 10 further includes a fluid circulation system 200 (also referred to herein as the hydraulic system) for circulating dishwashing fluid throughout the dishwasher 10. The fluid circulation system 200 may include various valves, hoses, pump assemblies, water lines, and other plumbing components (e.g., a booster heater, an energy saving device (ESD) comprising a shell and a tube heat exchanger, as known by one skilled in the art, etc.) for ultimately circulating dishwashing fluid (e.g., wash water carrying detergent, clean rinse water, etc.) about the dishware contained in the tub portion 12. According to some aspects, the fluid circulation system 200 may include a wash fluid circuit 220 and a rinse fluid circuit 240, wherein the wash fluid circuit 220 is discrete from the rinse fluid circuit 240. FIG. 1A illustrates a wash cycle implemented by the dishwasher 10, in which wash water is circulated through the wash fluid circuit 220 and onto the dishware in the tub portion 12. FIG. 1B illustrates a rinse cycle implemented by the dishwasher 10, in which rinse water is circulated through the rinse fluid circuit 240 and onto the dishware in the tub portion 12. Of course, in some instances, a single fluid circuit may be used for circulating both the wash water and the rinse water throughout the dishwasher 10. That is, the fluid circulation system 200 may comprise a single fluid circuit is some instances. In any event, the wash/rinse water may be pumped/re-circulated by one or more pump assemblies, out of the wash tank 16 to various water distribution provisions (e.g., wash spray arms 240 and rinse spray arms 242) mounted in the interior of the tub portion 12 for spraying the wash/rinse water, under pressure, onto the dishes, utensils, and other dishware contained therein. In this regard, the dishwashing fluid collected in the wash tank 16 may be re-circulated through the water distribution provisions during each of the wash and rinse cycles typically implemented by the dishwasher 10.

The fluid circulation system 200 may be connected to a house water supply line 18 by a water supply valve 20 (e.g., a solenoid valve). During the wash cycle, dishwashing fluid may be directly transported to the wash tank 16 via appropriate plumbing. In some instances, dishwashing fluid collected in the wash tank 16 may be mixed with dishwashing detergent and heated (e.g., greater than 55° C.) by a tank heating unit 22 for use during the wash cycle. The heated and detergent laden wash water may then be directed to the wash spray arms 222 through the wash fluid circuit 220 via a wash circulation pump assembly 224 and circulated onto the dishware in the tub portion 12. The dishwashing fluid is then gravity-fed to a filter member 24 for filtering the dishwashing fluid, and then collected again in the wash tank 16 for further use during the wash cycle.

During the rinse phase, the dishwashing fluid entering the fluid circulation system 200 via the water supply valve 20 may be directed to a heating unit 26 (e.g., a boiler) disposed along the rinse fluid circuit 240 such that the rinse water can be heated to a suitable level (e.g., equal to or greater than 82° C.) for sanitizing the dishware in the tub portion 12. After heating, the dishwashing fluid may be directed to the rinse spray arms 242 via a rinse circulation pump assembly 244 and circulated about the dishware in the tub portion 12 until a desired level of cleanliness is achieved. The dishwashing fluid may then filter through the filter member 24 for collection in the wash tank 16 where the dishwashing fluid may be available for further use during the rinse cycle. Of course, in some instances, the rinse water collected in the wash tank 16 may not be recycled or otherwise available for further use, wherein the collected rinse water may exit the dishwasher 10 via appropriate plumbing.

Further, a drain system may be connected to or otherwise in fluid communication with the wash tank 16 for removing the dishwashing fluid from the dishwasher 10 via a drain in the house or commercial establishment in which the dishwasher 10 is installed. In this regard, the drain system may include a drain pump assembly (not shown) configured to pump dishwashing fluid from the wash tank 16 to the drain line. A drain valve 70 may be in fluid communication with the wash tank 16 and disposed along the drain line. In some instances, the drain system may include an overflow line 28 in fluid communication with the wash tank 16 to prevent the water level in the tank from exceeding a predetermined threshold level within the wash tank 16.

In some instances, a controller device 50 of the dishwasher 10 may be configured to direct or otherwise execute various wash programs/cycles implemented by the dishwasher 10. In this regard, the controller device 50 may be configured to execute an appropriate action such as, for example, opening/closing valve members, actuating/de-actuating pump assemblies, or otherwise controlling components of the fluid circulation system. In some instances, the controller device 50 may be in electrical communication with a controller interface having actuators (e.g., button-type) of which a user can interact with to start/set/control the various wash programs/cycles capable of being implemented by the dishwasher 10. Accordingly, the dishwasher 10 is capable of executing various dishwasher programs for providing clean dishware.

As previously mentioned, however, insoluble solid limestone (calcium carbonate: CaCO₃) typically forms within the fluid circulation system 200 and/or the interior of the dishwasher 10 exposed to the wash/rinse water from the wash and rinse fluid circuits 220, 240. In this regard, limestone deposition may be exacerbated by the increased temperatures of the wash/rinse water circulated to the tub portion 12 via the wash and rinse fluid circuits 220, 240, causing various problems with the dishwasher 10, as previously described herein.

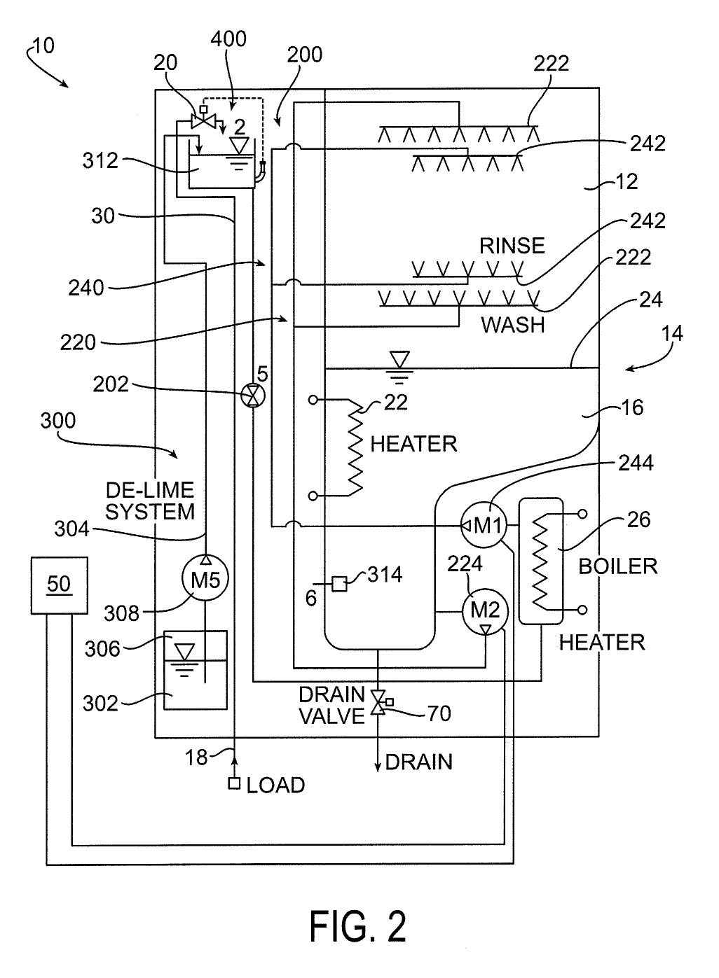

In accordance with embodiments of the present disclosure, with reference to FIGS. 2-5, the dishwasher 10 may thus include a descaling arrangement comprising a descale system 300 for descaling, reducing, or otherwise removing limestone deposition or other particle formations from the dishwasher 10, and particularly from the fluid circulation system 200 and inner surfaces/walls of the tub portion 12. The terms “descale” and “descaling” as used herein refer to removing a hard coating, such as, for example, limestone deposits, formed or otherwise encrusted within the fluid circulation system 200/hydraulic system of the dishwasher 10, the tub portion 12 of the dishwasher 10, or any other component forming a portion of the dishwasher 10. In the case of limestone deposition, the terms “delime” and “deliming” may be particularly used to describe the removal of limestone formations from a fluid circulation system component, a dishwasher surface, or a dishwasher component surface.

In this regard, the descale system 300 may be configured to inject, dispense, or otherwise introduce a descaling substance 302, fluid or agent into dishwashing fluid circulating within the fluid circulation system 200 such that a descaling procedure thereof is performed. The circulating dishwashing fluid carrying the descaling substance 302 may also be distributed to other portions/surfaces of the dishwasher 10 for descaling thereof, such as, for example, the inner walls of the tub portion 12. According to one embodiment, the descale system 300 may include a delivery line 304 in fluid communication with a reservoir 306 configured to store or otherwise contain the descaling substance 302. The delivery line 304 may also be in fluid communication with the fluid circulation system 200 of the dishwasher 10 at a descaling substance introduction point, generally designated as 400. A dispensing pump assembly 308 may be disposed along the delivery line 304, between the reservoir 306 and the descaling substance introduction point 400, so as to direct the descaling substance 302 into the fluid circulation system 200 upon actuation of the dispensing pump assembly 308, as directed by the controller device 50 or a discrete controller device.

In some embodiments, the descale system 300 may include a descaling substance level sensor 310 configured to determine or evaluate a descaling substance level status indicative of the amount of the descaling substance in reservoir 306, wherein such sensors are known by those skilled in the art. In such instances, the descaling substance level sensor 310 may interact with the descaling substance 302 contained in the reservoir 306 to determine the descaling substance level. The descaling substance level sensor 310 may be in communication with the controller device 50 such that a descaling procedure is prevented from being executed if the descaling substance level falls below a threshold level. In this regard, an indicium or indicia (e.g., a visual or aural indicium/indicia) may be provided via the controller device 50 to inform the user that the reservoir 306 needs refilling. According to other aspects, the reservoir 306 may be exposed or otherwise externally disposed with respect to the tub portion 12 or other portions creating a housing therefore so as to facilitate visual inspection of the remaining quantity of descaling substance 302 in the reservoir 306 to the user.

According to various aspects of the present invention, the descaling substance 302 may comprise various chemical/liquid substances effective at removing particle or limestone build-up within the dishwasher 10. For example, the descaling substance 302 may include a decalcifying and/or a de-liming liquid substance, such as, for example, a lime-calcium-rust remover product, LIME-A-WAY®, Ultra LIME-A-WAY®, or other descaling product in liquid form, or a solution created from a solid descaling product such as Solid LIME-A-WAY®, or any other suitable descaling product.

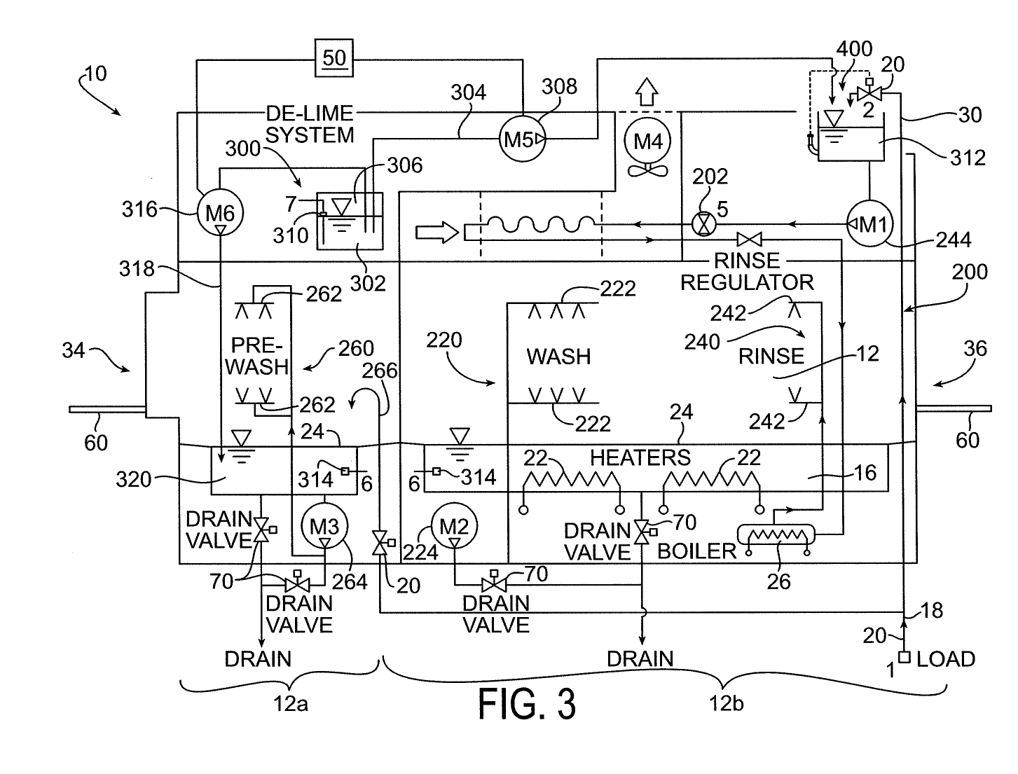

The descale system 300 may be in fluid communication or otherwise fluidly connected to the fluid circulation system 200 in various manners. According to one embodiment, the delivery line 304 of the descale system 300 may be in fluid communication with a mixing chamber 312 disposed at the descaling substance introduction point 400, as shown in FIGS. 2 and 3, such that the descaling substance 302 can be injected/dispensed/introduced into the mixing chamber 312. Also, a water supply line 30 may be in fluid communication with the mixing chamber 312 such that mixing of the dishwashing fluid from the water supply line 30 can be mixed with the descaling substance 302 in the mixing chamber 312. In such a configuration, a physical separation exists at the mixing chamber 312 that places the pressurized water from the water supply line 30 in communication with the atmosphere. As such, in one embodiment, the rinse circulation pump assembly 244 may be used to direct the descaling substance 302 carried by the dishwashing fluid through the rinse fluid circuit 240 and to the rinse water distribution provisions (e.g., rinse spray arms 242) for distributing the descaling substance 302 to the tub portion 12.

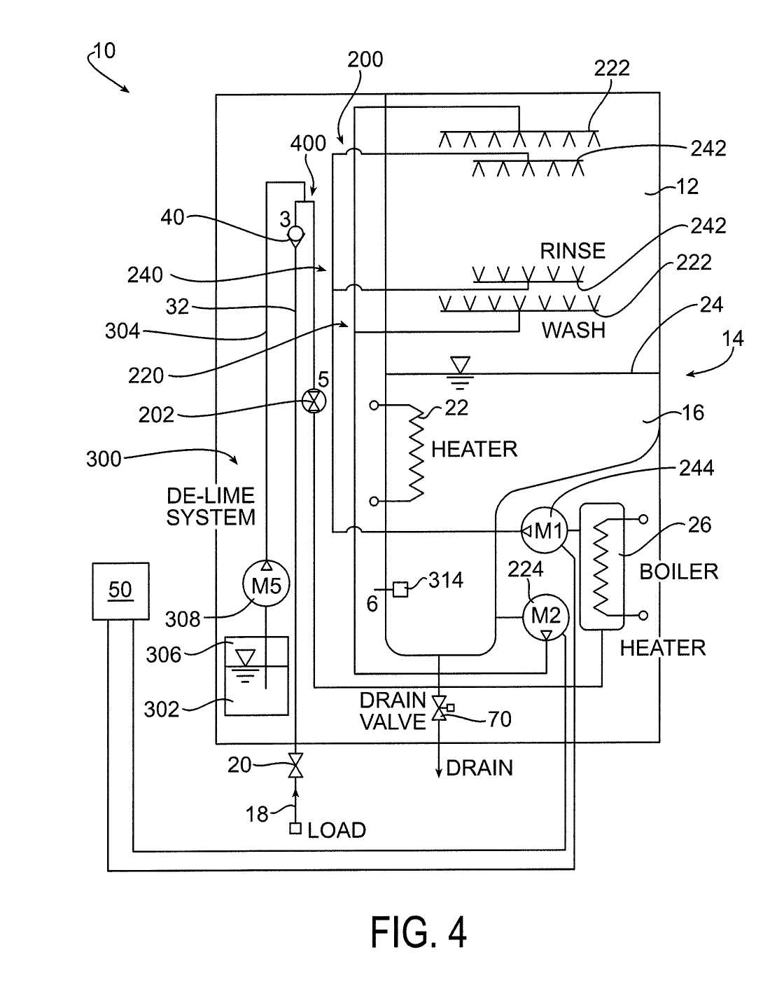

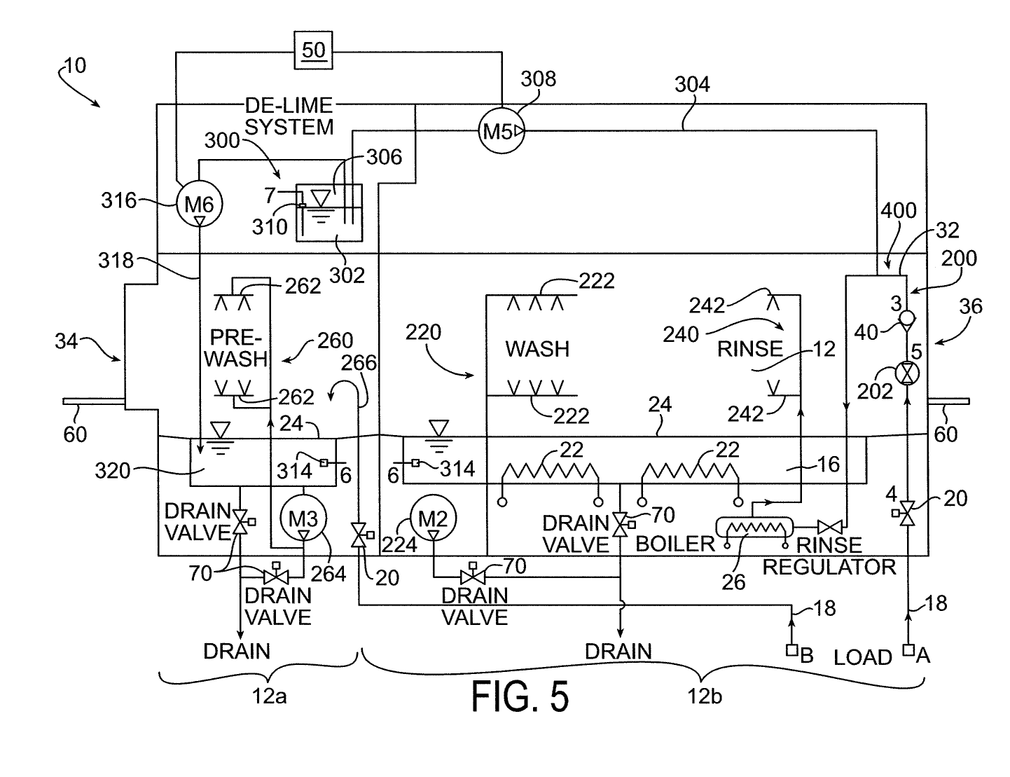

According to other embodiments, the delivery line 304 of the descale system 300 may be in fluid communication with a pressurized water supply line 32, as shown in FIGS. 4 and 5. In this regard, the delivery line 304 may be connected to the pressurized water supply line 32 via an appropriate valve member (not shown). As such, the descaling substance 302 may be injected/dispensed/introduced directly into the pressurized water supply line 32 of the fluid circulation system 200 of the dishwasher 10 at the descaling substance introduction point 400. To prevent backflow of dishwashing fluid containing the descaling substance 302 into the pressurized water supply line 32 upstream from the descaling substance introduction point 400, an anti-backflow device 40 such as, for example, a non-return valve, a flapper valve, a ball valve, or any other suitable one-way flow mechanism, may be included along the pressurized water supply line 32 prior to the descaling substance introduction point 400. That is, the anti-backflow device 40 may be configured to allow the dishwashing fluid to flow toward the descaling substance introduction point 400, while also being configured to prevent dishwashing fluid containing the descaling substance 302 from flowing past the anti-backflow device 40 toward the water supply valve 20.

Accordingly, the descale system 300 may be implemented for descaling/deliming the fluid circulation system 200 of the dishwasher 10, as well as descaling/deliming other portions/components of the dishwasher 10. For example, as shown in FIGS. 2-5, the descaling substance 302 may be introduced into the rinse fluid circuit 240, circulated therethrough via the rinse circulation pump assembly 244, and distributed in and about the tub portion 12 via the rinse water distribution provisions (e.g., rinse spray arms 242), wherein the descaling substance 302 carried by the dishwashing fluid is then gravity-fed to the filter member 24 and passed therethrough for collection in the wash tank 16. The collected dishwashing fluid carrying the descaling substance 302 may then be pumped out of the wash tank 16 via the wash circulation pump assembly 224 and circulated through the wash fluid circuit 220 for descaling thereof, wherein the dishwashing fluid carrying the descaling substance 302 is again distributed in and about the tub portion 12 via the wash water distribution provisions (e.g., wash spray arms 222). In addition, the descaling substance 302 may interact with the heating elements of the heating unit 26 disposed along the rinse fluid circuit 240 for providing descaling thereof. Furthermore, the tank heating unit 22 may also be subjected to the descaling substance 302 during a descaling procedure as described herein.

In some instances, a dilution sensor 314 may be provided for determining a descaling substance dilution level indicative of an amount of descaling substance 302 present in the dishwashing fluid circulating through the fluid circulation system 200 at a give time, such that it can be determined when the dishwasher 10 and its fluid circulation system 200 have been flushed of the descaling substance 302 to a desired level. In one aspect, the dilution sensor 314 may be disposed in the wash tank 16 or along the rinse fluid circuit 240 so as to evaluate in a direct or indirect manner the value of the dilution of the descaling substance 302 in the circulated dishwashing fluid. Further, the dilution sensor 314 may be in communication with the controller device 50 such that the dispensing pump assembly 308 can be actuated and de-actuated to control introduction of the descaling substance 302 for ensuring a predetermined dilution value. In other instances, a flow meter 202 may be disposed along the fluid circulation system 202 for determining dishwashing fluid flow rates, wherein actuation and de-actuation of the dispensing pump assembly 308 are controlled for time intervals based on the determined dishwashing fluid flow rates, so as to ensure a predetermined dilution value. In some instances, the predetermined dilution value may be, for example, between about 4-6%. Of course, the predetermined dilution value may be varied to any suitable or desired amount, including those outside of the 4-6% range specified herein, which is only provided as one example of a dilution range and is not meant to limit the present disclosure.

According to various embodiments of the present invention, the descale system 300 may be implemented in many different types of dishwashing appliances. For example, the descale system 300 may be implemented in a dishwasher having a so-called “fixed” dishwasher rack system or a dishwasher rack conveyor system. Of course, one skilled in the art will recognize that embodiments of the present invention may be implemented in other types of dishwashing appliances not specifically described herein. For example, embodiments of the present invention may be implemented in a hood type dishwasher having a telescoping or otherwise pivoting hood member that permits loading of the dishware within the dishwashing appliance, as known by those skilled in the art.

As shown in FIGS. 2 and 4, the dishwasher 10 may be of the type having a “fixed” dishwasher rack system, wherein the dishwasher 10 includes one or more dishwasher rack members (not shown) movable in and out of the tub portion 12, while remaining in operable engagement therewith. In such dishwasher types, the dishwasher 10 typically includes the tub portion 12 having a plurality of walls defining a forward access opening capable of being blocked by a door assembly. The dishwasher rack member is capable of receiving dishware therein and moving in and out of the forward access opening. Such dishwashers are often considered conventional residential-type dishwashers.

As shown in FIGS. 3 and 5, the dishwasher 10 may be of the type having a dishwasher rack conveyor system, wherein the dishwasher 10 includes or is otherwise in operable communication with a conveyor system 60 for moving dishware carried thereby in a first opening 34 defined by the tub portion 12 and out of a second opening 36 defined by the tub portion 12. Such dishwashers are often considered commercial or professional grade dishwashers used in restaurants or other industries requiring bulk and/or expedited dishware cleaning. In some instances, the dishwasher rack conveyor system may include a pre-wash section 12a of the tub portion 12 separate from a wash/rinse section 12b of the tub portion 12. In this regard, the descale system 300 may also be in fluid communication with a pre-wash fluid circuit 260 such that the descaling substance 302 is distributed throughout the pre-wash fluid circuit 260 and about the pre-wash section 12a via one or more pre-wash distribution provisions (e.g., pre-wash spray arms 262). According to one aspect, a supplemental dispensing pump assembly 316, discrete from the dispensing pump assembly 308, may direct the descaling substance 302 from the reservoir 306 via a supplemental delivery line 318 directly into a pre-wash tank 320 disposed about the lower end 14 of the pre-wash section 12a of the tub portion 12. In other instances, the supplemental delivery line 318 may be tied into a pre-wash water supply line 266 for directly introducing the descaling substance 302 into the pre-wash fluid circuit 260. In any instance, a pre-wash circulation pump assembly 264 may circulate the dishwashing fluid carrying the descaling substance 302 within the pre-wash fluid circuit 260 and about the pre-wash section 12a of the tub portion 12. In other instances, the pre-wash fluid circuit 260 may be in fluid communication with a supplemental descale system (not shown) discrete and independent from the descale system 300 used to descale the wash and rinse fluid circuits 220, 240.

According to some embodiments, the controller device 50 may be configured to direct an automatic descaling wash program, wherein the controller device 50 controls actuation of various pumps, valves, etc. for descaling the dishwasher 10 via implementation of the descale system 300. Such an automatic descaling wash program may be actuated by the user by, for example, interacting with an actuator type button on a controller device interface. In other instances, the automatic descaling wash program may be executed according to a predetermined routine programmed into the controller device 50, wherein the automatic descaling wash program is executed, for example, after a predetermined number of dishwasher cycles or after the elapse of a predetermined duration of time (e.g., executing the automatic descaling wash program once a month). Accordingly, execution of the descaling wash program may be automatic or subject to manual input. As described previously, the controller device 50 may provide an indicium/indicia to alert the user, for example, at predetermined intervals, of the need to execute the descaling wash program to remove limestone deposition within the dishwasher 10.

In one exemplary embodiment of the automatic descaling wash program as implemented by a dishwasher 10 having a “fixed” dishwasher rack system, the following steps may be executed. The washing wash tank 16 is substantially discharged of dishwashing fluid. Then, the dispensing pump assembly 308, the rinse circulation pump assembly 244 (in embodiments employing the mixing chamber 312), and the water supply valve 20 are actuated, so as to fill the wash tank 16 with clean water added with the proper percentage value of the descaling substance 302 (that can be set by the user within a predetermined range). In embodiments employing the mixing chamber 312, the descaling substance 302 is premixed to the dishwashing fluid in the mixing chamber 312 (e.g., a container) before being fed to the wash tank 16. In embodiments with and without the mixing chamber 312, loading of clean dishwashing fluid and of the descaling substance 302 are simultaneous. In this step, the descaling of the rinse fluid circuit 240 downstream from the descaling substance introduction point 400 is performed.

Once the filling of the wash tank 16 is complete, the heating unit 26 and the tank heating unit 22 are actuated, heating the dishwashing fluid within the wash tank 16 and the fluid circulation system 200 up to predetermined nominal values. The step of descaling from the inner surfaces of the dishwasher 10 and from the wash fluid circuit 220 is started by actuating the wash circulation pump assembly 224. Operation time of the wash circulation pump assembly 224 depends on the size of the dishwasher and the extent of overall incrustation, and, in some instances, customer preferences. The heating elements of the heating unit 26 and the tank heating unit 22 are actuated to maintain the water temperature at the preset values.

A new rinse step is then actuated, wherein the dispensing pump assembly 308 is de-actuated until the value of dilution of the descaling substance in the fluid circulation system is brought to approximately zero. The wash tank 16 is discharged by actuating the respective drain valve. During the discharge, the previous step may continue for a predetermined duration. Once the wash tank 16 has been discharged, it is refilled with clean water from the rinse fluid circuit 240 or with a direct connection pipe line. One or more inner washing steps are started, with the water just loaded, so as to substantially remove the aggressive descaling substance 302 from the inner walls of the tub portion 12 and from the fluid circulation system 200.

The final discharge step is started, that provides for the complete discharge of the rinse fluid circuit 240 (in embodiments employing the mixing chamber 312) and the total emptying of the wash tank 16. Also, the wash fluid circuit 220 and the wash circulation pump assembly 224 are completely discharged. Such an automatic descaling wash program as described is provided merely as an example of one possible program capable of being executed by the dishwasher 10/controller 50 and is not meant to limit the embodiments of the invention as disclosed herein.

In one exemplary embodiment of the automatic descaling wash program as implemented by a dishwasher 10 having a dishwasher rack conveyor system, the following steps may be executed. The washing wash tank 16 and the pre-wash tank 320 are substantially discharged of dishwashing fluid. Then, the dispensing pump assembly 308, the rinse circulation pump assembly 244 (in embodiments employing the mixing chamber 312), and the water supply valve 20 are actuated, so as to fill the wash tank 16 with clean water added with the proper percentage value of the descaling substance 302 (that can be set by the user within a predetermined range). In embodiments employing the mixing chamber 312, the descaling substance 302 is premixed to the dishwashing fluid in the mixing chamber 312 (e.g., a container) before being fed to the wash tank 16. In embodiments with and without the mixing chamber 312, loading of clean dishwashing fluid and of the descaling substance 302 are simultaneous. In this step, the descaling of the rinse fluid circuit 240 downstream from the descaling substance introduction point 400 is performed. If the pre-wash section 12a is present, the supplemental dispensing pump assembly 316 is actuated so as to achieve, once the pre-wash tank 320 is filled, the desired dilution value of the descaling substance 302.

Once the filling of the wash tank 16 is complete, the heating unit 26 and the tank heating unit 22 are actuated, heating the dishwashing fluid within the wash tank 16 and the fluid circulation system 200 up to predetermined nominal values. The step of descaling from the inner surfaces of the dishwasher 10 and from the rinse and wash fluid circuits 220, 240 is started by actuating the respective wash and rinse circulation pump assemblies 224, 244. Operation time of the wash circulation pump assembly 224 depends on the size of the dishwasher and the extent of overall incrustation, and, in some instances, customer preferences. The heating elements of the heating unit 26 and the tank heating unit 22 are actuated to maintain the water temperature at the preset values.

A new rinse step is then actuated, wherein the dispensing pump assembly 308 is de-actuated until the value of dilution of the descaling substance in the fluid circulation system is brought to approximately zero. The wash tank 16 and the pre-wash tank 320 are discharged by actuating the respective drain valve. During the discharge, the previous step may continue for a predetermined duration. Once the wash tank 16 and the pre-wash tank 320 have been discharged, each is refilled with clean water from the rinse fluid circuit 240 or with a direct connection pipe line. One or more inner washing steps are started, with the water just loaded, so as to substantially remove the aggressive descaling substance 302 from the inner walls of the tub portion 12 and from the fluid circulation system 200.

The final discharge step is started, that provides for the complete discharge of the rinse fluid circuit 240 (in embodiments employing the mixing chamber 312) and the total emptying of the wash tank 16 and the pre-wash tank 320. Also, the wash fluid circuit 220 and the wash circulation pump assembly 224 are completely discharged, as well as the pre-wash fluid circuit 260 and the pre-wash circulation pump assembly 264. Such an automatic descaling wash program as described is provided merely as an example of one possible program capable of being executed by the dishwasher 10/controller 50 and is not meant to limit the embodiments of the invention as disclosed herein.

In yet another exemplary embodiment of the automatic descaling wash program as implemented by a dishwasher 10, the following steps may be executed.
Initial pause;
Empty completely the tanks (e.g., the wash tank 16);
Load the air gap (mixing chamber 312) until the working level is reached (to avoid pump cavitations);
Inject delime (descaling substance 302) in the air gap (mixing chamber 312) until dilution is 4% (using a 300 ml/min peristaltic pump it takes about 70 sec);
Reload the wash tank 16 with water and descaling substance 302 until the correct tank level is reached; when the tank working level is reached the heating of the boiler (heating unit 26) and tank (tank heating unit 22) start; during this phase the peristaltic pump is switched on or off in order to maintain the desired percentage;
The wash tank 16 is heated until set point (60° C.=140° F.);
Switch on the wash circulation pump assembly 224 to delime the wash tank 16; wash tank heating is enabled via the tank heating unit 22;
Rinse the rinse fluid circuit 240 with clean water;
Drain the wash tank 16 and rinse the rinse fluid circuit 240 with clean water in the same time;
Load the wash tank 16 with fresh water; during this phase it is used wash tank loading valve and the rinse circulation pump assembly 244;
Clean the wash tank 16 with fresh water;
Pause between two wash tank 16 cleanings;
Clean the wash tank 16 with fresh water;
Drain the air gap (mixing chamber 312); and
Drain completely tanks and pumps.

Many modifications and other embodiments of the inventions set forth herein will come to mind to one skilled in the art to which these inventions pertain having the benefit of the teachings presented in the foregoing descriptions and the associated drawings. For example, in some instances, the descale system 300 may be in direct fluid communication with the wash tank 16, which forms a portion of the overall fluid circulation system 200, such that the descaling substance 302 is introduced into the fluid circulation system 200 via the dishwashing fluid collected in the wash tank 16. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for the purposes of limitation.

That which is claimed:

1. A descaling arrangement for a dishwasher having a tub portion adapted to receive dishware therein, the dishwasher further having a fluid circulation system adapted to circulate dishwashing fluid about the dishware within the tub portion, the descaling arrangement comprising:
a descale system adapted to be in fluid communication with the fluid circulation system, the descale system being configured to selectively introduce a descaling substance into dishwashing fluid circulated within the fluid circulation system such that the descaling substance is distributed to at least one of the tub portion and the fluid circulation system for descaling thereof.

2. A descaling arrangement according to claim 1, wherein the descaling substance comprises one of a decalcifying, a deliming liquid substance, a solution created from a decalcifying solid substance, and a solution created from a deliming solid substance.

3. A descaling arrangement according to claim 1, wherein the descale system comprises a descaling substance reservoir and a dispensing pump assembly in fluid communication therewith, the dispensing pump assembly being configured to direct the descaling substance contained in the descaling substance reservoir to the fluid circulation system.

4. A dishwasher, comprising:
a tub portion adapted to receive dishware therein;
a fluid circulation system configured to circulate dishwashing fluid about the dishware within the tub portion; and
a descale system in fluid communication with the fluid circulation system, the descale system being configured to selectively introduce a descaling substance into dishwashing fluid circulated within the fluid circulation system such that the descaling substance is distributed to at least one of the tub portion and the fluid circulation system for descaling thereof.

5. A dishwasher according to claim 4, wherein the descaling substance comprises one of a decalcifying, a deliming liquid substance, a solution created from a decalcifying solid substance, and a solution created from a deliming solid substance.

6. A dishwasher according to claim 4, wherein the fluid circulation system includes a water supply valve adapted to fluidly connect the fluid circulation system to a house water supply line, the descale system being in fluid communication with the fluid circulation system downstream from the water supply valve with respect to the flow direction of dishwashing fluid entering the fluid circulation system.

7. A dishwasher according to claim 6, wherein the fluid circulation system and the descale system connect in fluid communication at a descaling substance introduction point, and the fluid circulation system further comprises an anti-backflow device disposed between the descaling substance introduction point and the water supply valve to prevent backflow of the descaling substance into the house water supply line.

8. A dishwasher according to claim 4, wherein the fluid circulation system includes a washing fluid circuit configured to circulate, via at least one wash water distribution provision of the washing fluid circuit, wash water having a detergent substance carried thereby about the dishware within the tub portion, the fluid circulation system further having a rinse fluid circuit discrete from the washing fluid circuit, the rinse fluid circuit being configured to circulate, via at least one rinse water distribution provision of the rinse fluid circuit, heated rinse water about the dishware within the tub portion, the descale system being in fluid communication with the rinse fluid circuit.

9. A dishwasher according to claim 8, wherein the rinse fluid circuit of the fluid circulation system comprises a heating unit configured to heat dishwashing fluid moving through the rinse fluid circuit, the descale system being disposed upstream from the heating unit with respect to the flow direction of dishwashing fluid entering the fluid circulation system.

10. A dishwasher according to claim 4, further comprising a controller device configured to direct a plurality of automatic dishwasher programs to be executed by the dishwasher, including an automatic descaling program whereby the controller device is configured to selectively control introduction of the descaling substance into the fluid circulation system.

11. A dishwasher according to claim 10, wherein the fluid circulation system comprises a dilution sensor in communication with the controller device, the dilution sensor being configured to determine a descaling substance dilution level indicative of an amount of descaling substance present in the dishwashing fluid circulating through the fluid circulation system.

12. A dishwasher according to claim 10, wherein the descale system comprises a dispensing pump assembly in fluid communication with a descaling substance reservoir, the dispensing pump assembly being in communication with the controller device and being configured to direct the descaling substance contained in the descaling substance reservoir to the fluid circulation system.

13. A dishwasher according to claim 12, wherein the descale system further comprises a descaling substance level sensor in communication with the controller device, the descaling substance level sensor being adapted to interact with the descaling substance contained in the descaling substance reservoir and being configured to determine a descaling substance level status indicative of the amount of the descaling substance in the descaling substance reservoir.

14. A dishwasher according to claim 4, further comprising at least one rack member disposed within the tub portion, the rack member being configured to receive dishware therein and being movable into and out of the tub portion.

15. A dishwasher according to claim 4, further comprising a rack conveyor system in operable communication with the tub portion, the rack conveyor system being configured to automatically transport dishware in and out of the tub portion.

16. A dishwasher according to claim 4, wherein the fluid circulation system further comprises a mixing chamber for facilitating fluid communication between the fluid circulation system and the descale system, the mixing chamber being adapted to receive dishwashing fluid from a house water supply line and to receive the descaling substance from the descale system such that the descaling substance is capable of being mixed with the dishwashing fluid.

17. A method of descaling at least one of a tub portion and a fluid circulation system of a dishwasher, the fluid circulation system being configured to circulate dishwashing fluid about dishware received within the tub portion, the method comprising:
selectively introducing a descaling substance via a descale system into dishwashing fluid circulating within the fluid circulation system such that the descaling substance is carried by the dishwashing fluid throughout the fluid circulation system, the descale system being in fluid communication with the fluid circulation system; and
circulating the dishwashing fluid and the descaling substance carried thereby within at least one of the tub portion and the fluid circulation system for descaling thereof.

18. A method according to claim 17, wherein selectively introducing a descaling substance further comprises selectively introducing a descaling substance comprising one of a decalcifying, a deliming liquid substance, a solution created from a decalcifying solid substance, and a solution created from a deliming solid substance.

19. A method according to claim 17, wherein selectively introducing a descaling substance via a descale system further comprises selectively introducing a descaling substance via a descale system disposed downstream, with respect to the flow direction of dishwashing fluid entering the fluid circulation system, from a water supply valve adapted to fluidly connect the fluid circulation system to a house water supply line.

20. A method according to claim 17, wherein circulating the dishwashing fluid and the descaling substance carried thereby further comprises circulating the dishwashing fluid and the descaling substance carried thereby within a washing fluid circuit of the fluid circulation system and a rinse fluid circuit of the fluid circulation system, the washing fluid circuit being configured to circulate wash water having a detergent substance carried thereby about the dishware within the tub portion, the rinse fluid circuit being configured to circulate heated rinse water about the dishware within the tub portion, and the rinse fluid circuit being discrete from the washing fluid circuit and in fluid communication with the descale system such that the descaling substance is introduced into the rinse fluid circuit.

21. A method according to claim 20, further comprising heating the dishwashing fluid moving through the rinse fluid circuit and carrying the descaling substance such that the heated rinse water carrying the descaling substance is circulated about the tub portion for descaling thereof.

22. A method according to claim 17, further comprising actuating via a controller device an automatic descaling program to be executed by the dishwasher, whereby the controller device is configured to selectively control introduction of the descaling substance into the fluid circulation system.

23. A method according to claim 22, further comprising determining a descaling substance dilution level via a dilution sensor in communication with the controller device, the descaling substance dilution lever being indicative of an amount of descaling substance present in the dishwashing fluid circulating through the fluid circulation system.

24. A method according to claim 22, wherein selectively introducing a descaling substance via a descale system further comprises selectively introducing a descaling substance via a descale system comprising a dispensing pump assembly in fluid communication with a descaling substance reservoir, the dispensing pump assembly being configured to direct the descaling substance stored in the descaling substance reservoir to the fluid circulation system, as directed by the controller device.

25. A method according to claim 24, further comprising determining a descaling substance level status via a descaling substance level sensor in communication with the controller device and configured to interact with the descaling substance contained in the descaling substance reservoir, the descaling substance level status being indicative of the amount of the descaling substance in the descaling substance reservoir.

26. A method according to claim 17, wherein circulating the dishwashing fluid and the descaling substance carried thereby within at least one of the tub portion and the fluid circulation system further comprises circulating the dishwashing fluid and the descaling substance carried thereby within at least one of the fluid circulation system and the tub portion having at least one rack member disposed therewithin, the rack member being configured to receive dishware therein and being movable into and out of the tub portion.

27. A method according to claim 17, wherein circulating the dishwashing fluid and the descaling substance carried thereby within at least one of the tub portion and the fluid circulation system further comprises circulating the dishwashing fluid and the descaling substance carried thereby within at least one of the fluid circulation system and the tub portion having a rack conveyor system in operable communication therewith, the rack conveyor system being configured to automatically transport dishware in and out of the tub portion.

28. A method according to claim 17, selectively introducing a descaling substance via a descale system into dishwashing fluid moving within the fluid circulation system further comprises selectively introducing a descaling substance via a descale system into dishwashing fluid moving within the fluid circulation system having a mixing chamber for facilitating fluid communication between the fluid circulation system and the descale system, the mixing chamber being adapted to receive dishwashing fluid from a house water supply line and to receive the descaling substance from the descale system such that the descaling substance is capable of being mixed with the dishwashing fluid.
